(19) United States
(12) Patent Application Publication
(10) Pub. No.: US 2026/0010399 A1
(43) Pub. Date: Jan. 8, 2026

(54) System and method for monitoring and adjusting energy use by computational devices

(71) Applicant: Bank of America Corporation, Charlotte, NC (US)

(72) Inventors: George A. Albero, Charlotte, NC (US); Naga Vamsi Krishna Akkapeddi, Charlotte, NC (US); Saurabh Arora, Gurugram (IN)

(21) Appl. No.: 18/761,892

(22) Filed: Jul. 2, 2024

(51) Int. Cl. G06F 9/48

(52) U.S. Cl. CPC G06F 9/4893

(57) ABSTRACT

A system for improving energy use associated with an application includes a processor configured to receive performance data from a device associated with the application for a first period of time and updates energy-use data stored in memory with the received performance data. The processor then determines an energy use value based at least in part upon the energy use data stored in the memory. When the energy use value is greater than a predetermined threshold, the processor analyzes the energy use data using machine learning, which produces suggested changes to the application that are determined by machine learning to reduce the energy use value. The processor then initiates the suggested changes by sending the suggested changes to the device associated with the application.

### TECHNICAL FIELD

The present disclosure relates generally to networked computing and, more specifically, to a system and method for monitoring and adjusting energy use by computational devices.

### BACKGROUND

Large organizations often utilize complex computing systems, such as data centers, to carry out day-to-day operations. In these systems, many applications and computing devices may be operating. As applications become more complex, the computing devices hosting them are called upon to perform more operations while also maintaining or improving their speed. This often results in the computing devices using more electrical energy, which may have an environmental impact. Therefore, there is a need to make the applications and associated computing systems more efficient in their use of electrical energy.

### SUMMARY

The system and method disclosed in the present application provide a technical solution to the technical problems discussed above by providing the capability to determine energy use associated with one or more applications automatically. The system and method then determine suggested application changes that will potentially decrease energy usage. When these suggested changes are implemented, the computational and network resources may be reduced, resulting in less energy needed by the computational device hosting the application to perform the application.

In one embodiment, the disclosed system and method improves energy use associated with an application. The system includes a memory configured to store energy use data associated with the application, wherein the energy use data comprises an application type and performance data associated with the application. The system also includes a processor operably coupled to the memory. The processor is configured to receive performance data from a device associated with the application for a first period of time. The application performs at least one operation, and the performance data comprises an identity of the at least one operation and the number of times the at least one operation is performed by the application over the first period of time. The processor updates the energy use data stored in the memory with the received performance data and determines an energy use value based at least in part upon the energy use data stored in the memory.

When the energy use value is greater than a predetermined threshold, the processor analyzes the energy use data using machine learning that has been trained on other energy use data and other energy use values determined for at least one other application of the same type. Using the analysis, the processor performing machine learning may produce suggested changes to the application that may reduce the energy use value. These suggested changes are then sent to the device associated with the application, where they may be implemented.

The disclosed system provides several practical applications, such as automatically reducing the number of operations required during an application's normal performance. By reducing the number of operations required during an application's normal performance, the number of computational devices required to host the application may be reduced as well. The reduced number of operations and/or reduced amount of computational devices may potentially reduce the electrical power needed for hosting the application reducing the wear and tear on the computational devices as well as potentially reducing carbon emissions. This may also result in less cooling being needed and/or less electricity being required to house the computational devices hosting the application, potentially resulting in reduced carbon emissions. Utilizing the disclosed system and method requires fewer computational resources, resulting in a potential reduction in the number of data centers and/or their components needed for performing the applications. This may result in many other benefits, including environmental benefits and efficiency benefits. These technical advantages improve the underlying computer and network systems by making them more secure and efficient.

Certain embodiments of the present disclosure may include some, all, or none of these advantages. These advantages and other features will be more clearly understood from the following drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates one embodiment of a system configured for monitoring and adjusting energy use by an external device;

FIG. 2 illustrates one embodiment of a flowchart for monitoring and adjusting energy use by an external device; and

FIG. 3 illustrates one embodiment of an example of using a system for monitoring and adjusting energy use by an external device.

### DETAILED DESCRIPTION

### System, Overview

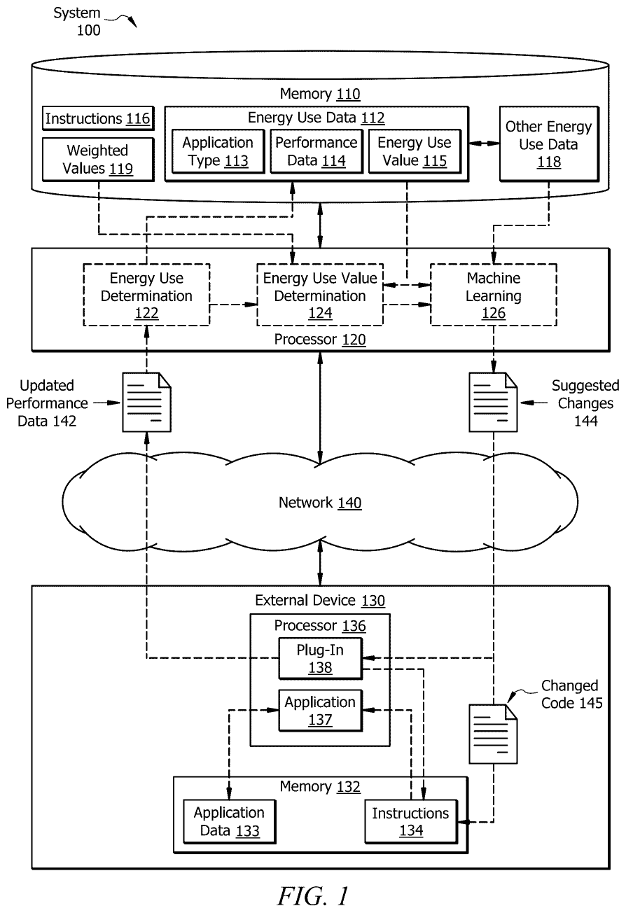

FIG. 1 is a schematic diagram of a system 100 configured for monitoring and adjusting energy use by an external device 130. More specifically, system 100 is configured to receive updated performance data 142 from an external device 130 that hosts at least one application 137 and provide suggested changes 144 back to the external device 130 for modifying the application 137. The updated performance data 142 may comprise data related to how many times operations of various types that the processor 136 of the external device 130 performs over a first period of time. These operations may be such things as application programming interface (API) calls, batch cycles, open threads, and/or any other operations associated with the application that the processor 136 of the external device 130 performs when hosting and executing an application 137. The processor 120 performing a machine learning operation 126 is able to analyze the updated performance data 142 as well as stored performance data 114 in the memory to produce suggested changes 144. The suggested changes 144 may make any change to the external device 130 and/or application 137 that may reduce the amount or cost of the power used by the external device 130 when performing application 137.

In one embodiment, system 100 comprises an external device 130, a network 140, a processor 120, and a memory 110. The processor 120 and memory 110 are in signal communication through the network 140 with the external device 130. The system 100 may be configured as shown or in any other suitable configuration.

### External Device

The external device 130 may include any number of devices that perform one or more applications 137. Examples of an external device 130 may include, but are not limited to, computers, laptops, mobile devices (e.g., smartphones or tablets), servers, clients, automated teller machines (ATM), point of sale devices (POS), or any other suitable type of devices that may be used for accessing or supporting an application 137. While only one external device 130 is shown, in one or more embodiments, a plurality of external devices, e.g., 130, may be present, each hosting an application 137 or a plurality of applications, e.g., 137. In one or more embodiments, the application 137 hosted by the external device 130 may be a decentralized application and/or may take any other form and may be hosted by more than one external device, e.g., 130.

The external device 130 includes at least one processor 136 that performs one or more processes or operations, including performing the application 137, hosting a plug-in 138, sending the updated performance data 142, and receiving the suggested changes 144. The processor 136 executes instructions 134 stored in the memory 132 to perform the application 137 as well as the optional plug-in 138. The application 137 may include web pages, database applications, banking applications, word processing applications, entertainment applications, video applications, and/or any other applications that an organization may have hosted by the external device 130.

When executing the application 137, the processor 136 may perform various operations. The processor 136 may make API calls, perform batch jobs, modify application data 133 stored in memory 132, and modify application data stored in other external devices (not shown). The processor may also perform one or more mathematical and logical operations, start and/or maintain active threads, and send and/or receive data or other information through and from the network 140. The processor 136 may perform other operations not listed above without departing from the disclosure; those listed are provided only as examples.

The processor 136, in one or more embodiments, may host an optional plug-in 138 installed on the external device 130 by the processor 120 or other external systems (not shown). Alternatively, the optional plugin 138 is part of the application 137 and is installed with the application 137. The plug-in 138 gathers information on the number and type or identity of operations performed by the processor 136 while hosting the application 137. The plug-in prepares the updated performance data 142 to be sent through the network 140 to the processor 120. The plug-in 138 may prepare any other information needed for the processor 120 to determine updated energy use data and an updated energy value. This may also include application type information as well as information on the external device 130, such as, but not limited to, the amount of electricity and/or other resources needed for each operation. The plug-in also receives the suggested changes 144 from the processor 120 and may implement them. This may include changing one or more lines of code in the application 137 in order to obtain more efficient operation of the application 137 and/or processor 136. The plug-in 138 may be provided to the external device 130 from the processor 120 or may be part of an application 137 or from another source. Alternatively, or in addition, in one or more embodiments, the plug-in 138 may be located in a separate device connected by the network 140 or by other means to the processor 136.

The external device 130 may include a memory 132 for storing instructions 134 for performing the application 137 and the optional plug-in 138. The memory 132 may also include application data 133 for the application 137. In one or more embodiments, the memory 132 may also store in the application data 133 the number and type of operations performed by the processor 136 when performing the application 137.

The memory 132 may be any type of storage for storing instructions 134 for executing by the processor 136 as well as application data 133 used by and/or produced by the application 137. The memory 132 may be a non-transitory computer-readable medium in operative communication with the processor 136. The memory 132 may be one or more disks, tape drives, or solid-state drives. Alternatively, or in addition, the memory 132 may be one or more cloud storage devices. The memory 132 may be volatile or non-volatile. It may comprise read-only memory (ROM), random-access memory (RAM), ternary content-addressable memory (TCAM), dynamic random-access memory (DRAM), and static random-access memory (SRAM).

While FIG. 1 shows the external device 130, including only a single processor 136 and a memory 132, they may include any suitable number and combination of processors, e.g., 136 and memories 132, as well as any other necessary components. For simplicity, only one processor, e.g., 136, and one memory, e.g., 132, are shown in FIG. 1.

### Network

The network 140 may be any suitable type of wireless and/or wired network including, but not limited to, all or a portion of the Internet, an intranet, a private network, a public network, a peer-to-peer network, the public switched telephone network, a cellular network, a local area network (LAN), a metropolitan area network (MAN), a wide area network (WAN), and a satellite network. The network 140 may be configured to support any suitable type of communication protocol as would be appreciated by one of ordinary skill in the art.

The network 140 may connect the external device 130 with the processor 120 and memory 110. Alternatively, network 140 may connect the external device 130 through the Internet or other large networks. In one or more embodiments, different elements of system 100 may be at different geographic locations and connected through network 140. While shown as a single network 140, the network 140 may comprise a plurality of components of any suitable networking equipment, including but not limited to routers and switches, that allow at least the external device 130 to communicate with the processor 120 and/or memory 110. Network 140 is not limited to the configuration shown in FIG. 1, which is simply shown in this form for simplicity and explanatory purposes.

### Memory

Memory 110 may be any type of storage for storing a computer program comprising instructions 116, energy use data 112, and other energy use data 118. The memory 110 may be a non-transitory computer-readable medium in operative communication with the processor 120. The memory 110 may be one or more disks, tape drives, or solid-state drives. Alternatively, or in addition, the memory 110 may be one or more cloud storage devices. The memory 110 may be volatile or non-volatile. It may comprise read-only memory (ROM), random-access memory (RAM), ternary content-addressable memory (TCAM), dynamic random-access memory (DRAM), and static random-access memory (SRAM).

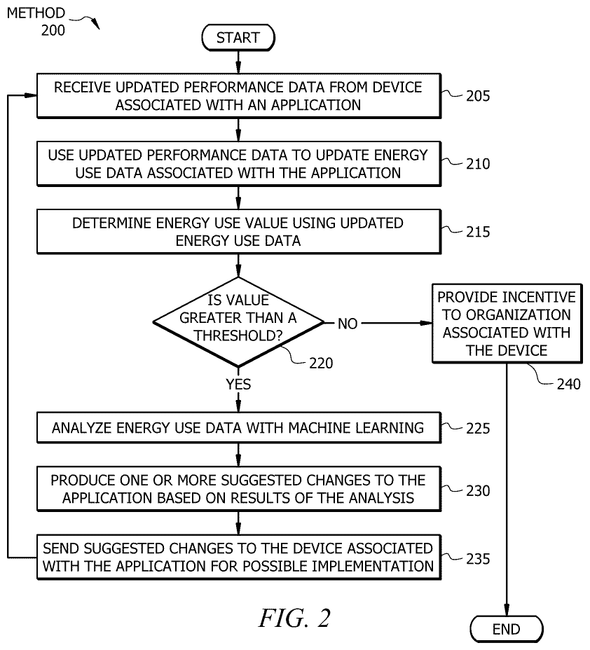

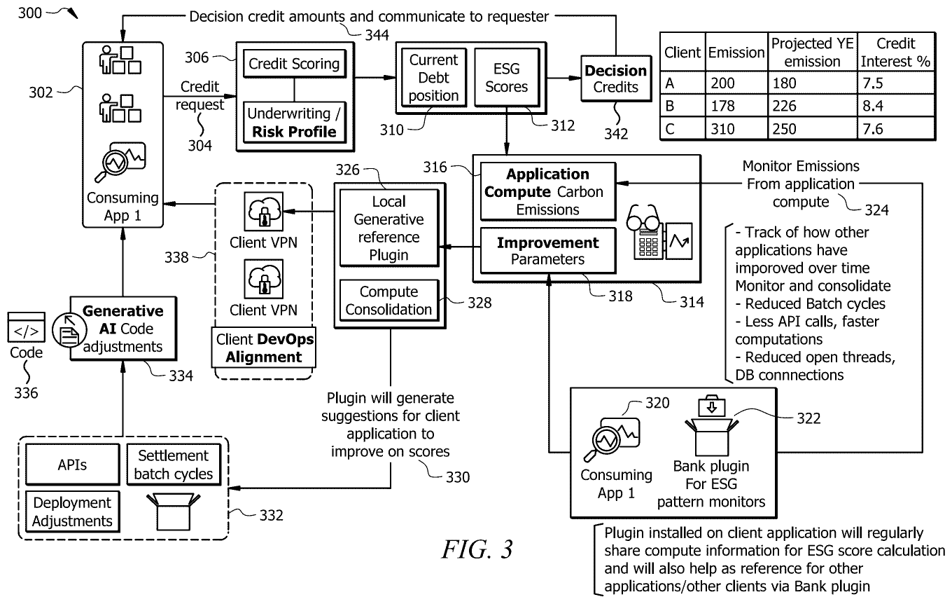

The memory 110 stores instructions 116, which, when executed by the processor 120, causes the processor 120 to perform the operations shown in FIGS. 2 and 3 described below. Instructions 116 may comprise any suitable set of instructions, logic, rules, or code. Memory 110 may include storage that may take the form of a database for storing things such as energy use data 112, other energy use data 118, and weight values 119. These may be stored and recalled using known protocols such as SQL, XML, and/or any other protocol or language that a user, administrator, or developer of the system 100 wishes to use. The instructions 116, energy use data 112, other energy use data 118, weighted values 119, and any other information stored in memory 110 may be stored in different forms, and the disclosure is not limited to storing the instructions 116, energy use data 112, other energy use data 118, and weighted values 119 as a database.

The memory 110 in one or more embodiments stores energy use data 112. The energy use data 112 may include application type 113 and performance data 114 related to application 137. As will be described in more detail below regarding FIGS. 2 and 3, the processor 120, when it receives updated performance data 142, stores the updated performance data 142 in the energy use data 112 with any previous data as the performance data 114 that has been collected. When no previous performance data 114 has been collected in one or more embodiments, the updated performance data 142 becomes the performance data 114 saved as energy use data 112 in memory 110. The energy use data 112 may also include such things as application type 113 and an energy use value 115. The energy use value 115 may be produced by the processor 120 when performing an energy use value determination 124 and may be used to determine if suggested changes 144 should be produced. The energy use value 115 may also be compared to previous energy use values (not shown) that are stored in the other energy use data 118. The energy use data 112 may also store any other information needed for performing an energy use determination 122. For example, in a non-limiting example, the energy use data 112 may also need to store information about the type and actual energy use of the external device 130 and/or its processor 136. The energy use data 112 may also store information related to energy availability; for example, if it is desirable to use more solar energy, information on when solar energy is available may be stored. Any other information may be stored as energy use data 112 in the memory 110 without departing from the disclosure.

The memory 110 may also store other energy use data 118, which may include the same or different information than the energy use data 112. In one or more embodiments, the other energy use data 118 may comprise performance data, e.g., 114 and application type, e.g., 113 that has been collected from other external devices 130 and/or application, e.g., 137. This information may be used by the processor 120 performing a machine learning operation 126 to determine the suggested changes 144, which will be described in more detail below, along with a discussion of the machine learning operation 126 performed by the processor 120.

The memory 110 may also store other weighted values 119. In one or more embodiments the weighted values 119 may include a first weighted value for a first operation type and a second weight value for a second operation type and additional weighted values for each additional operation type. Each weighted value 119 is predetermined for a particular type of operation included in the performance data 114. The weighted values 119 may also be different for different types of applications 137. The weighted values 119 in one or more embodiments may be percentages or may be a multiple depending on how an organization determines an energy use value 115. This information may be used by the processor 120 when performing the energy use determination 124, which will be described in more detail below.

### Processor

The processor 120 may take the form of any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 120 may be a programmable logic device, a microcontroller, a microprocessor, or any suitable combination of the preceding. The processor 120 is communicatively coupled to and in signal communication with the memory 110. The one or more processors making up the processor 120 are configured to process data and may be implemented in hardware or software. For example, the processor 120 may be 8-bit, 16-bit, 32-bit, 64-bit, or of any other suitable architecture. The processor 120 may include an arithmetic logic unit (ALU) for performing arithmetic and logic operations; processor registers that supply operands to the ALU and store the results of ALU operations, and a control unit that fetches instructions 116 from memory 110 and executes them by directing the coordinated operations of the ALU, registers and other components.

The processor 120 is in operative communication with memory 110 and configured to implement various instructions 116 stored in memory 110. The processor 120 may be a special-purpose computer designed to implement the instructions 116 and/or functions disclosed herein. For example, the processor 120 may be configured to perform operations, including those described below and shown in FIGS. 2 and 3.

The processor 120 may perform an energy use determination 122, an energy use value determination 124, and a machine learning operation 126 based on instructions 116 stored in the memory 110. The processor 120 may perform more or less operations than shown in FIGS. 2 and 3; the specific operations shown are only examples. While a single processor 120 is shown, the processor 120 may include a plurality of processors or computational devices. The operations, e.g., energy use determination 122, energy use value determination 124, and machine learning operation 126, described herein as being performed by the processor 120 may be performed by a separate processor 120 or software application executed on a single computational device, e.g., processor 120, or they may be located on separate servers, separate datacenters such as a cloud server and/or one or more of the external devices 130.

In one or more embodiments, the processor 120 receives updated performance data 142 from an external device 130 via network 140. The updated performance data 142 is then stored by the processor 120 in memory 110 to update the performance data 114 of the energy use data 112. The updated performance data 142 and/or performance data 114 are then used by the processor 120 in one or more embodiments to perform an energy use value determination 124.

In one or more embodiments, the processor 120, when performing the energy use value determination 124, uses the performance data 114 to determine the number of times each type of operation is performed by the processor 136. For example, the processor 136 may perform a first number of API calls and a second number of batch cycles while opening and closing a third number of windows, threads, or other operations that utilize energy to be performed. Each of these operations uses a predetermined amount of electricity or power that may be determined based on the application type 113 as well as information related to the processor 136 and memory 132 of the external device 130.

The processor 120, when performing the energy use value determination 124, takes the number of operations for each operation type and applies a predetermined weight stored as a weight value 119 in the memory 110. The resulting weighted number of operations for the operation type is then added together with other resulting weighted number of operations for other operation types performed during the performance of the application 137 to determine the energy use value 115. For example, if API calls receive a 0.25 weight while batch cycles receive a 0.5 weight, the energy use value would be 0.25 times the number of API calls plus 0.5 times the number of batch cycles. Alternatively, or in addition, the processor 120 performing the energy use value determination 124 may perform other or additional methods for determining the energy use value 115, and these methods may consider such things as API calls, batch cycles, active threads, network messages, time of day, energy source, network 140 congestion, or any other criteria and/or combinations of operations. Any weight, number of operations, and method of determining the energy use value 115 may be performed without departing from the disclosure, and the previous examples are only provided as examples.

Once processor 120 finishes performing the energy use value determination 124, it compares the determined energy use value 115 with a predetermined threshold. The threshold may be set by a user, administrator, developer, or other entity concerned about the amount of energy used when performing application 137. In one or more embodiments, the threshold may be set based on environmental, social, and governance (ESG) criteria set by an organization or a governmental body. In one or more embodiments, incentives may be provided to application 137 and/or external device 130 based on the energy use value 115 being less than the threshold.

In one or more embodiments, if the energy use value 115 is less than the threshold, then the updated performance data 142 and performance data 114 are combined and stored along with the energy use value 115 with other energy use data 118 in the memory 110. Alternatively, the energy use value 115 may be compared to previous energy use values stored in the other energy use data 118 instead of a threshold; if the difference between the previous energy use value and current energy use value 115 is less than a threshold, in one or more embodiments, the processor proceeds to perform the machine learning operation 126.

If the processor 120 determines that the energy use value 115 is greater than a threshold, then the processor 120 applies a machine learning operation 126. The processor 120, when performing the machine learning operation 126, may use any machine learning algorithm to determine suggested changes 144 to the application 137 and/or the external device 130 that would potentially reduce the energy use of the external device 130 when performing the application 137. In one or more embodiments, the processor 120, when performing the machine learning operation 126, may use generative artificial intelligence (GenAI) that has been trained on previous energy-use data stored as other energy use data 118 in memory 110 to determine one or more code changes to suggest to the external device 130 as suggested changes 144. Other machine learning algorithms such as, but not limited to, supervised and unsupervised models, artificial neural networks, and/or any other models and methods may be used to generate code and/or other suggested changes 144, and the disclosure is not limited to GenAI.

Once the processor 120 performs the machine learning operation 126, it produces one or more suggested changes 144 that it sends to the external device 130 through the network 140 for possible implementation. The suggested changes 144 may provide changed code 145 for use in the application 137; the changed code 145 may reduce the frequency and/or number of operations the processor 136 uses to perform the application 137 and/or make any other change that would reduce the amount or cost of the power used by the processor 136 when performing the application 137. The suggested changes 144 may reduce the number of API calls by combining one or more API calls together. The suggested changes 144 may reduce energy use by combining batch jobs and/or other functions that the processor 136 performs. For example, in a non-limiting example, if currently the application 137 updates data in a database every hour, but the data only changes significantly every day, the suggested changes 144 may cause the application to only update the database once a day, resulting in little or no noticeable impact in the function of the application 137. In another non-limiting example, if a device performing an application processes a transaction and sends it to an external server in real-time, but the processor 120 performing the machine learning operation 126, determines that the data related to the transaction is only needed to be sent once an hour, the suggested changes 144, may be to cache the transaction data and only send it once an hour, reducing the amount of network and computational resources needed for performing the transactions, resulting in a decrease in energy usage. Other suggested changes 144 may be made without departing from the disclosure, and the disclosure is not limited to the examples described above.

### Process for Monitoring and Adjusting Energy Use by an External Device

FIG. 2 is a flowchart of an embodiment of method 200 performed by a processor 120 for monitoring and adjusting energy use by an external device 130. The processor 120 may execute instructions 116 stored in the memory 110, which employs method 200 for monitoring and adjusting the energy use of the external device 130 when performing an application 137.

Method 200 begins at operation 205 when processor 120 receives updated performance data 142 from the external device 130 associated with application 137. This updated performance data 142 may be the first performance data 114 received from the external device 130, or it may be updated performance data 142 that is received periodically, such as, but not limited to, once a day, once an hour, once a month, or any other time period that is useful for performing method 200. The updated performance data 142 may include the identity of as well as a number of operations. The operation may include such things as batch cycles, API calls, DB connections, open threads, and/or other data that may be used to determine the energy use of the external device 130 when performing application 137 over a predetermined period of time. More or less data may be included in the updated performance data 142, and the updated performance data 142 is not limited to the above examples. Additionally, the updated performance data 142 may include such things as application type, external device type, energy prices, and/or other information needed for calculating an energy use value and/or an ESG score.

Once the updated performance data 142 is received from the external device 130 in operation 205, the updated performance data 142 is used to update the energy use data 112 associated with the application 137 in operation 210. This updated energy use data 112 in one or more embodiments is stored in the memory 110 for use by the processor 120 when performing the energy use determination 122, the energy use value determination 124, and/or as other energy use data 118 for use by the processor 120 when performing a machine learning operation 126. Once the energy use data 112 is updated in operation 210, method 200 proceeds to operation 215.

In operation 215, processor 120 determines an energy use value 115 using the updated energy use data 112, which was updated with the updated performance data 142 in operations 205 and 210. The energy use value 115 may be determined by the processor 120 performing any method that a particular organization, user, or government entity requires. The energy use value 115 may take the form of an energy value or measurement, or it may take the form of an ESG score, which combines other information besides a simple energy value. In one or more embodiments, the energy use value 115 is calculated by applying to each type of operation that the application 137 requires the processor 136 to perform, a predetermined weighted value 119 for that type of operation. By applying the predetermined weighted value 119, a weighted energy use value for that operation may be determined by the processor 120. The various weighted energy use values are then added together to produce an energy use value 115 in operation 215. Other methods of producing the energy use value 115 may be used without departing from the disclosure, and the described method is only a non-limiting example.

Once the energy use value 115 is determined by processor 120 in operation 215, processor 120 determines if the energy use value 115 is greater than the threshold in operation 220. This threshold may be based on an ESG goal or a reduced energy goal that an organization has or may be based on an incentive structure for providing a resource such as will be described below with respect to the example of FIG. 3. If the energy use value 115 is greater than the threshold in operation 220, the processor 120 then analyzes the energy use data 112 with machine learning in operation 225.

In operation 225, the processor 120 performs a machine learning operation 126 to analyze the energy use data 112 and produces in operation 230 one or more suggested changes to the application 137. The machine learning operation 126 may utilize a GenAI to analyze the energy use data 112. This GenAI may have been trained on other energy use data 118 related to data collected from other external devices (not shown) performing applications that are the same or of a similar type as application 137. The processor 120 performing the machine learning operation 126 produces one or more suggested changes in operation 230; these may take the form of GenAI-produced new or replacement code for the application, or they may take the form of a suggestion for implementation by a user, operator, administrator, or other party. These suggested changes 144 may be such things as reducing the frequency of API calls or the frequency of batch cycles during subsequent periods of time. Other changes may be suggested without departing from the disclosure.

Once the suggested changes are produced in operation 230, the processor 120 sends the suggested changes 144 to the external device 130 associated with the application 137 for possible implementation in operation 235. If the external device 130 either automatically implements the suggested changes 144 or they are implemented by a user or administrator, the method 200 returns to operation 205, and operations 205-235 are repeated until the energy use value is determined in operation 220 to be less than the threshold.

If the energy use value is determined to be less than the threshold in operation 220, the method 200 proceeds to an optional operation 240. In operation 240, an incentive may be provided to an organization associated with the external device 130. For example, in the non-limiting example of FIG. 3 described below, the organization may receive a discount on interest rates for credit. Other incentives may be provided, or no incentive may be provided. Once operation 240 is completed, method 200 of FIG. 2 ends.

### Example of Using a System for Monitoring and Adjusting Energy Use by an External Device

FIG. 3 is a non-limiting example of a process 300 for monitoring and adjusting energy use by an external device 130. FIG. 3 is shown as an example of a specific application, and the disclosure is not limited to the application shown in FIG. 3. The example of FIG. 3 may be performed by system 100 described above and shown in FIG. 1 or may use any system or components able to perform the example. In the example application, an organization or device 302 or an organization performing at least one application 320 performs a credit request 304 or other resources from an organization or business (not shown). The emission or ESG score 312 is then used along with other information, such as but not limited to credit scoring and underwriting risk profile 306 and current debt position 310, to make credit decisions 342.

In the example, a credit request 304 is received from the organization or device 302. The credit request 304 then undergoes credit scoring and an underwriting/risk profile 306. From the information generated by the credit scoring and underwriting/risk profile 306, a current debt position 310 may be determined. The current debt position 310 and ESG scores 312 are then used to make a credit decision 342, which is implemented and/or communicated 344 to the organization or device 302.

In one or more embodiments, the ESG score is determined by computing carbon emissions 316 related to the application. The carbon emissions are related to energy use. They may be equivalent to the energy use data 112 stored in memory 110 as described above regarding FIG. 1. The carbon emissions 316 used by an application 320 are calculated by monitoring emissions 324 or energy use related to the application 320. This may be done by plugin 322, which is configured to monitor the application 320. The plugin 322 determines such things as batch cycles, API calls, database connections, and open threads over a period of time. This information is used to compute the carbon emissions 316 or energy use for the application 320 as well as for computing improvement parameters 318.

The improvement parameters 318 are analyzed by a local generative reference plugin 326. This plugin may be performing any machine learning algorithm, including GenAI. The local generative reference plugin 326 is used to consolidate 328, the various improvement parameters 318, and generate 330, one or more suggestions 332. These suggestions 332 may include changes in API calls, settlement batch cycles, and deployment adjustments. In one or more embodiments, the local generative reference plugin 326 may be used to determine code adjustments 334, which comprises new or modified changed code 336 for implementation in the application 320. Alternatively, or in addition, the suggestions from the generative AI code adjustment 334 may be communicated through a client VPN 338 or through any appropriate method or system.

Once the changed code 336 or suggestions from the local generative reference plugin 326 are implemented, the plug-in 322 determines application carbon emission 316 and utilizes this to update the ESG scores 312. These updated ESG scores 312, along with current debt position 310, are then used to modify and/or make a credit decision in 342. For example, suppose the application initially results in an emission level of three hundred and ten and is reduced to two hundred. In that case, the organization requesting the credit might receive a credit incentive of a reduced credit rate when the credit decision 342 is made. This incentive and/or a credit decision 344 are sent to the organization requesting the credit.

The present examples are to be considered illustrative and not restrictive, and the intention is not to be limited to the details given herein. For example, the various elements or components may be combined or integrated into another system, or certain features may be omitted or not implemented.

While several embodiments have been provided in the present disclosure, it should be understood that the disclosed systems and methods might be embodied in many other specific forms without departing from the spirit or scope of the present disclosure. The present examples are to be considered illustrative and not restrictive, and the intention is not to be limited to the details given herein. For example, the various elements or components may be combined or integrated into another system, or certain features may be omitted or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

To aid the Patent Office and any readers of any patent issued on this application in interpreting the claims appended hereto, applicants note that they do not intend any of the appended claims to invoke 35 U.S.C. § 140(f) as it exists on the date of filing hereof unless the words “means for” or “operation for” are explicitly used in the particular claim.

1. A system for improving energy use associated with an application, comprising:
a memory configured to store energy use data associated with the application, wherein the energy use data comprises an application type and performance data associated with the application; and
a processor operably coupled to the memory and configured to:
receive from a device associated with the application, the performance data for a first period of time, wherein the application performs at least one operation, and the performance data comprises an identity of the at least one operation and a number of times the at least one operation is performed by the application over the first period of time;
update the energy use data stored in the memory with the received performance data;
determine an energy use value based at least in part upon the energy use data stored in the memory;
when the energy use value is greater than a predetermined threshold, analyze the energy use data using machine learning that has been trained on other energy use data and other energy use values determined for at least one other application having a same application type as the application;
produce with the machine learning suggested changes to the application that are determined by the machine learning to reduce the energy use value; and
initiate the suggested changes by sending the suggested changes to the device associated with the application.

2. The system of claim 1, wherein the machine learning comprises generative artificial intelligence (GenAI).

3. The system of claim 1, wherein the received performance data is received from a plug-in installed on the device associated with the application.

4. The system of claim 3, wherein the plug-in implements the suggested changes to the application.

5. The system of claim 1, wherein the suggested changes comprise one or more changes to code associated with the application.

6. The system of claim 1, wherein the at least one operation is an application programming interface (API) call, and the suggested changes include reducing a frequency of API calls during subsequent periods of time.

7. The system of claim 1, wherein the at least one operation is a batch cycle associated with the application, and the suggested changes include reducing a frequency of batch cycles during subsequent periods of time.

8. The system of claim 1, wherein the at least one operation comprises a first operation of a first type and a second operation of a second type, wherein the first type and the second type are different.

9. The system of claim 8, wherein determining the energy use value comprises:
using a first predetermined weight associated with the first type and the number of times that the first operation is performed to obtain a first weighted value;
using a second predetermined weight associated with the second type and the number of times that the second operation is performed to obtain a second weighted value; and
combining the first weighted value and the second weighted value to obtain the energy use value.

10. A method for improving energy use associated with an application:
receiving from a device associated with the application, performance data for a first period of time, wherein the application performs at least one operation, and the performance data comprises an identity of the at least one operation and a number of times the at least one operation is performed by the application over the first period of time;
determining an energy use value based at least in part upon the received performance data;
analyzing, when the energy use value is greater than a predetermined threshold, the received performance data using machine learning that has been trained on other performance data and other energy use values determined for at least one other application having a same application type as the application;
producing with the machine learning suggested changes to the application that are determined by the machine learning to reduce the energy use value; and
initiating the suggested changes by sending the suggested changes to the device associated with the application.

11. The method of claim 10, wherein the machine learning comprises generative artificial intelligence (GenAI).

12. The method of claim 10, wherein the suggested changes comprise one or more changes to code associated with the application.

13. The method of claim 10, wherein the at least one operation is an application programming interface (API) call, and the suggested changes include reducing a frequency of API calls during subsequent periods of time.

14. The method of claim 10, wherein the at least one operation is a batch cycle associated with the application, and the suggested changes include reducing a frequency of batch cycles during subsequent periods of time.

15. A non-transitory computer-readable medium storing instructions that, when executed by a processor, cause the processor to:
receive from a device associated with an application, performance data for a first period of time, wherein the application performs at least one operation, and the performance data comprises an identity of the at least one operation and a number of times the at least one operation is performed by the application over the first period of time;
determine an energy use value based at least in part upon the received performance data;
analyze, when the energy use value is greater than a predetermined threshold, the received performance data using machine learning that has been trained on other performance data and other energy use values determined for at least one other application having a same application type as the application;
produce with the machine learning suggested changes to the application that are determined by the machine learning to reduce the energy use value; and
initiate the suggested changes by sending the suggested changes to the device associated with the application.

16. The non-transitory computer-readable medium of claim 15, wherein the machine learning comprises generative artificial intelligence (GenAI).

17. The non-transitory computer-readable medium of claim 15, wherein the suggested changes comprise one or more changes to code associated with the application.

18. The non-transitory computer-readable medium of claim 15, wherein the at least one operation is an application programming interface (API) call, and the suggested changes include reducing a frequency of API calls during subsequent periods of time.

19. The non-transitory computer-readable medium of claim 15, wherein the at least one operation is a batch cycle associated with the application, and the suggested changes include reducing a frequency of batch cycles during subsequent periods of time.

20. The non-transitory computer-readable medium of claim 15, wherein the at least one operation comprises a first operation of a first type and a second operation of a second type, wherein the first type and the second type are different.
